(19) United States
(12) Patent Application Publication
(10) Pub. No.: US 2025/0250290 A1
(43) Pub. Date: Aug. 7, 2025

(54) Metal-Organic Framework (MOF) Compositions, Process of Making and Process of Use Thereof

(71) Applicant: NuMat Technologies, Inc., Chicago, IL (US)

(72) Inventors: Brian G. Hashiguchi, Naperville, IL (US); Mitchell Hugh Weston, Chicago, IL (US)

(73) Assignee: NuMat Technologies, Inc., Chicago, IL (US)

(21) Appl. No.: 18/679,173

(22) Filed: May 30, 2024

Related U.S. Application Data
(60) Provisional application No. 63/471,783, filed on Jun. 8, 2023.

(51) Int. Cl. C07F 7/00; B01D 53/04; B01J 20/22

(52) U.S. Cl. CPC C07F 7/00; B01D 53/0407; B01J 20/226; B01D 2253/204; B01D 2257/406

(57) ABSTRACT

Disclosed herein are metal-organic framework (MOF) compositions, methods of preparing them and processes using them. A MOF composition comprises a plurality of metal nodes, a plurality of organic linkers, a plurality of organic ligands and a metal salt such as a metal halide. These MOF compositions are capable of capturing a target chemical in a gas stream. The target chemical may be ammonia.

### CROSS-REFERENCE TO RELATED APPLICATIONS

This application claims priority from U.S. Provisional Application No. 63/471,783, filed Jun. 8, 2023, which is incorporated herein in its entirety.

### STATEMENT REGARDING FEDERALLY SPONSORED RESEARCH OR DEVELOPMENT

This invention was made with U.S. Government support under Agreement No. N68335-21-C-0653 awarded by The United States Department of the Navy. The Government has certain rights in the invention.

### FIELD OF THE DISCLOSURE

Disclosed herein are metal-organic framework (MOF) compositions, methods of preparing the MOF compositions and materials comprising the MOF compositions, and processes of using them. The MOF composition comprises a plurality of metal nodes, a plurality of organic linkers, a plurality of organic ligands and a metal salt such as a metal halide. These compositions are capable of capturing a target chemical in a gas stream. In one embodiment the target chemical may be ammonia.

### BACKGROUND OF THE DISCLOSURE

Adsorbent materials are well known and have found uses in a number of applications such as air filtration, gas delivery, etc. One particular use for adsorbents is in removing or abating target chemicals in various gas streams. An important use is in removing Toxic Industrial Compounds (TIC) present in gas streams, including air streams.

TICs can be classified as either basic or base forming compounds or acidic or acid forming compounds. Usually, an adsorbent will exhibit adsorption capacity for various TICs. Capacity for each target chemical or TIC is dependent on the properties of the adsorbent, resulting in materials that often perform well at adsorbing one TIC but not multiple TICs. For example, the MOF adsorbent, Zr-BDC-NH2 has been shown to have high adsorption capacity for NO2 but modest capacity for ammonia. The ammonia filtration capacity of Zn-BDC-NH2 can be enhanced by impregnating the MOF with metal chloride salts enabling good adsorption capacity for both NO2 and NH3 as shown in US20210379559A1. Another MOF adsorbent, MOF-808, has been shown to have moderate NO2 removal ability. Filters that must abate multiple TICs are routinely required in a wide range of industries. These technologies typically utilize multiple adsorbents. That is, the capacity for one TIC may be sufficient to abate a target TIC in a particular gas stream, but not high enough to abate another TIC in the same gas stream. This necessitates the use of multiple adsorbents in order to abate two or more TICs in a gas stream such as air.

There is a need for adsorbent materials that can adsorb or abate one or more TICs from fluid streams, and in particular from gas streams such as air streams, industrial gas streams, off-gassing streams, or pollutant gas streams. In some cases, it would be further desirable to provide adsorbent materials that can adequately adsorb or abate two or more TICs from such fluid streams.

US2019/0091503 discloses MOFs such as UiO-66 can be impregnated with a metal compound such as a metal hydroxide or metal hydride to disperse the metallic compound either on the surface or in the pores of the MOF. The '503 published application states that these impregnated metallic compounds have catalytic properties which can destroy chemical warfare agents (CWA) such as sarin.

Solvent-assisted ligand incorporation (SALI) processes have also been used for functionalizing the channels of metal-organic framework (MOF) materials such as NU-1000 that offer substitutionally labile zirconium (IV) coordination sites with phosphonate-terminated ligands.

In one aspect, disclosed herein is a class of MOF compositions having enhanced adsorption for basic materials, particularly ammonia.

In another aspect, disclosed herein is a class of MOF compositions which are expected to have enhanced adsorption capacity for basic compounds such as ammonia while maintaining good adsorption capacity for acidic compounds such as nitrogen dioxide or chlorine.

### SUMMARY OF THE DISCLOSURE

In one embodiment, a metal-organic framework (MOF) composition comprises a plurality of metal nodes each having at least two coordination sites; a plurality of organic linkers, wherein the metal nodes are connected by the organic linkers bound at one or more coordination sites on the metal nodes to form an initial metal-organic framework; a plurality of organic ligands each comprising a coordination group bound to a coordination site of a metal node, each organic ligand further comprising at least one functional group; and a metal salt interacting with the framework to provide the metal organic framework composition. Also disclosed herein are materials and articles comprising the disclosed metal organic framework composition.

The metal nodes may comprise a metal oxo cluster comprising at least 2 metal atoms, M, selected from Zr, V, Al, Fe, Cr, Co, Ti, Hf, Cu, Zn, Ni, In, Ce, and mixtures thereof. The organic linkers comprise at least two groups which can bind to the metal nodes, such as carboxylic acid groups. In one embodiment, the organic linkers may be selected from the group consisting of 1,3,5-benzenetricarboxylic acid, 1,4-benzenedicarboxylic acid, 1,3-benzenedicarboxylic acid, functionalized derivatives thereof, and combinations thereof.

The coordination group of the organic ligand may be selected from one or more of carboxylate, phosphonate, phosphonite, sulfonate, and sulfinate. The metal salt may be selected from a halide, sulfate, carbonate, acetate, carboxylate, sulfonate, nitrate, or mixtures thereof. A specific embodiment is where the metal salt is a halide salt.

A second embodiment of the disclosure is a method of manufacturing the MOF composition comprising the steps of synthesizing an initial metal-organic framework comprising metal nodes connected by organic linkers; contacting the initial MOF with a first solution comprising an organic ligand and a ligand incorporation solvent to form a ligand-modified MOF; contacting the ligand-modified MOF with a second solution comprising a metal salt and a salt impregnation solvent; and separating the MOF from the solution to provide the disclosed MOF composition. Optionally, the MOF composition can be activated.

A further embodiment is a method of capturing a target chemical in a fluid stream, the method comprising providing a solid adsorbent comprising a MOF composition as disclosed herein and contacting a fluid stream comprising at least one target chemical with the solid adsorbent, whereby at least some of the target chemical is adsorbed by the solid adsorbent. The at least one target chemical may be ammonia and may be present in a concentration of from about 1 ppb to about 10%. The solid adsorbent comprises a MOF composition which comprises a plurality of metal nodes each having at least two coordination sites, a plurality of organic linkers, wherein the metal nodes are connected by the organic linkers bound at one or more coordination sites on the metal nodes to form a metal-organic framework; a plurality of organic ligands each comprising a coordination group bound to a coordination site of a metal node, each organic ligand having at least one functional group; and a metal salt interacting with the framework.

These and other aspects of the of the disclosure will become clearer in view of the following detailed description and the drawings.

### BRIEF DESCRIPTION OF THE DRAWINGS

FIG. 1 shows decoration of MOF-808 with the organic ligand tartaric acid.

FIG. 2 shows decoration of MOF-808 with the organic ligand gallic acid.

FIG. 3 shows a perspective of the initial steps of the overall process herein where metal salts are combined with an organic linker to form a MOF which is then decorated with an organic ligand bound to the coordination sites. Zr is illustrated as the metal M; 1,3,5-benzenetricarboxylic acid as the organic linker; and gallic acid as the organic ligand.

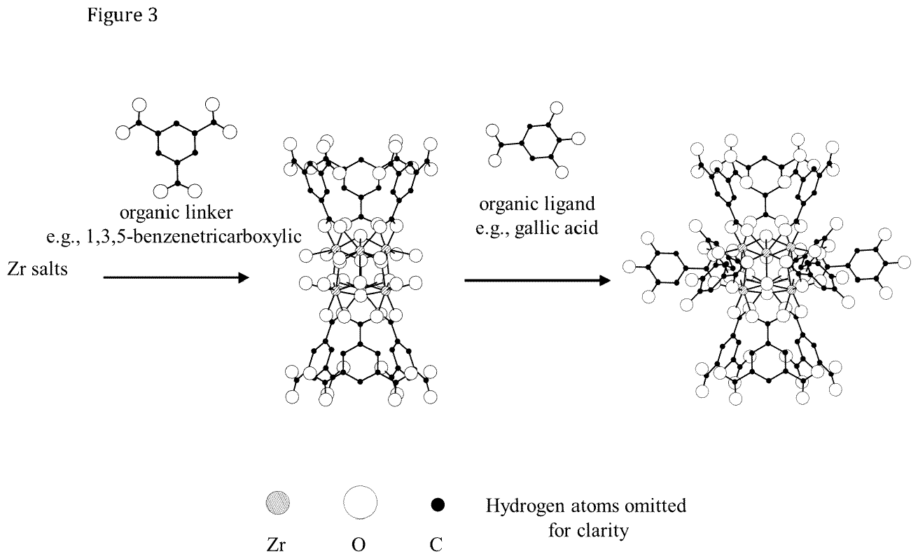

### Definitions

Metal-organic frameworks (MOF) are the coordination product of metal ions and at least bidentate organic linkers. MOFs comprise metal ion corner atoms or clusters referred to as metal nodes and organic linker molecules which connect the metal nodes to form a framework having high surface area, crystalline structures, and uniformly sized pores. Ligands are the organic molecules which are appended to the metal node through coordination groups on the ligand and, unlike linkers, do not join metal nodes together to form a crystalline framework. The organic ligands have at least one functional group in addition to the coordination group.

The term “MOF composition” or “metal organic framework composition” as used herein refers to the metal organic framework of metal nodes and linkers and including the coordinated organic ligands and the metal salt interacting with the framework, as disclosed herein.

The term “material comprising a MOF composition” as used herein refers to a composition comprising a MOF composition as defined above, and optionally comprising other ingredients including but not limited to any one or more of binders, additional adsorbents, and other additives.

The term “derive” or “derivative”, in the context of the present disclosure, means that the organic linkers can be present in the framework material in partially deprotonated, or completely deprotonated, form. In addition, the organic linker can comprise a substituent, or independently of one another, a plurality of substituents. Non-limiting examples of such substituents include —OH, —NH2, —OCH3, —CH3, —NH(CH3), —N(CH3)2, —CN and also halides.

The term “decorated” as used herein refers to a MOF framework having functional organic ligands coordinated to the framework. For example, a MOF decorated with gallic acid has gallic acid ligand molecules coordinated to a metal node-linker framework. A decorated MOF is also referred to herein as a ligand-modified MOF.

As used throughout the specification and the claims by “substantially” is meant at least 70% or at least 80% or at least 90% or at least 95%.

### DETAILED DESCRIPTION OF THE DISCLOSURE

Metal-organic frameworks (MOFs) are a well-known class of materials comprising metal nodes joined by organic linkers to form a crystalline framework having high surface area and uniformly sized pores.

Metal-organic frameworks may be referred to by proper name such as UiO-66 or MOF-808 or by topology, i.e. network structure. Names and topologies are compiled in databases linked from the International Commission on Metal-Organic Frameworks webpage at MOF Structures-Metal-Organic Frameworks-International Commission (mof-international.org).

For example, the MOF UiO-66 comprises a metal node comprising a Zr6O4 (OH)4 metal oxo cluster connected by up to about 12 1,4-benzene-dicarboxylate (i.e. BDC) organic linkers through carboxylate functions originating from the dicarboxylic acids to coordination sites on the metal node thereby forming a face-centered cubic lattice (fcu topology). Another MOF, MOF-808, comprises a metal node comprising the same Zr604 (OH)4 metal oxo cluster, but connected by up to about 6 benzene-1,3,5-tricarboxylate (i.e. BTC) organic linkers through carboxylate functions originating from the tricarboxylic acids to coordination sites on the metal node thereby forming a 6-connected spn topology.

MOF compositions disclosed herein comprise a plurality of metal nodes each having at least two coordination sites, a plurality of organic linkers, wherein the metal nodes are connected by the organic linkers bound at one or more coordination sites on the metal nodes to form a metal-organic framework; the framework further comprising a plurality of organic ligands each comprising a coordination group bound to a coordination site of a metal node, each organic ligand further comprising at least one functional group; and a metal salt interacting with the framework.

Metal nodes of the MOFs include metal atoms, M, which may be selected from the group including but not limited to Zr, V, Al, Fe, Cr, Co, Ti, Hf, Cu, Zn, Ni, In, Ce, and mixtures thereof. Preferably, said plurality of metal nodes comprise a metal oxo cluster comprising at least 2 metal atoms, M, selected from Zr, V, Al, Fe, Cr, Co, Ti, Hf, Cu, Zn, Ni, In, Ce, and mixtures thereof. A preferred subset of the above metals may include but is not limited to Zr, Hf, Al, Fe, Cu, and Zn, and mixtures thereof. In one embodiment the metal nodes may comprise any of zirconium, hafnium, and mixtures thereof. In one embodiment at least some of said metal nodes may comprise zirconium.

Metal oxo clusters may comprise two or more metal atoms bridged by oxygen atoms. Metal oxo clusters may comprise dibridged oxygen atoms represented as M-O-M or single oxygen atoms typically as hydroxyl groups M-OH. Metal oxo clusters may have more or fewer hydroxyl groups through elimination or addition of water to the metal oxo cluster. For example, the previously mentioned Zr6O4 (OH)4 metal oxo cluster may eliminate water to form a Zr6O5 (OH)2 metal oxo cluster. Coordination sites may comprise hydroxyl groups, oxo groups, or metal sites on said metal oxo clusters and may comprise combinations thereof. In one embodiment, coordination sites on said metal oxo clusters may comprise hydroxyl groups.

Organic linkers are organic molecules comprising at least two groups which can bind to the metal nodes, such as carboxylate functionalities. Carboxylate functionalities may bind to metal nodes at coordination sites to form a metal-organic framework. Organic linkers comprising at least two carboxylate functionalities may be selected from dicarboxylic, tricarboxylic, or tetracarboxylic acids.

The organic linker may be a dicarboxylic acid, such as, for instance, oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzene-dicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzene-dicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylim idazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclo-hexadiene-1,2-dicarboxylic acid, octanedicarboxylic acid, pentane-3,3-dicarboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-binaphthyidicarboxylic acid, 7-chloro-8-methylquinoline-2,3-dicarboxylic acid, 1-anilinoanthraquinone-2,4′-dicarboxylic acid, poly-tetrahydrofuran-250-dicarboxylic acid, 1,4-bis(carboxymethyl) piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazine-dicarboxylic acid, 4,4′-diamino (diphenyl ether)diimidedicarboxylic acid, 4,4′-diaminodiphenylmethanediimidedicarboxylic acid, 4,4′-diamino (diphenyl sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4 (1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptane-dicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitro-benzene-1,4-dicarboxylic acid, heptane-1,7-dicarboxylic acid, cyclobutane-1,1-dicarboxylic acid, 1,14-tetradecanedicarboxylic acid, 5,6-dehydronorbonane-2,3-dicarboxylic acid, 5-ethyl-2,3-pyridinedicarboxylic acid or camphordicarboxylic acid.

The organic linker may be a tricarboxylic acid such as 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methyl-benzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

The organic linker may be a tetracarboxylic acid such as 1,1-dioxidoperylo[1,12-BCD]thiophene-3,4,9,10-tetracarboxylic acid, perylene-tetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octane-tetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

MOF compositions as disclosed herein preferably comprise a plurality of organic linkers selected from the group consisting of 1,3,5-benzenetricarboxylic acid, 1,4-benzenedicarboxylic acid, 1,3-benzenedicarboxylic acid, functionalized derivatives thereof, and combinations thereof. Functionalized derivatives of the linkers may comprise one or more substituents including but not limited to —OH, —NH2, —OCH3, —CH3, —NH(CH3), —N(CH3)2, —CN and also halides. In one embodiment the functionalized derivatives are amino derivatives of the organic linker. For example, an amino functionalized derivative of 1,4-benzenedicarboxylic acid is 2-amino-1,4-benzenedicarboxylic acid (BDC-NH2).

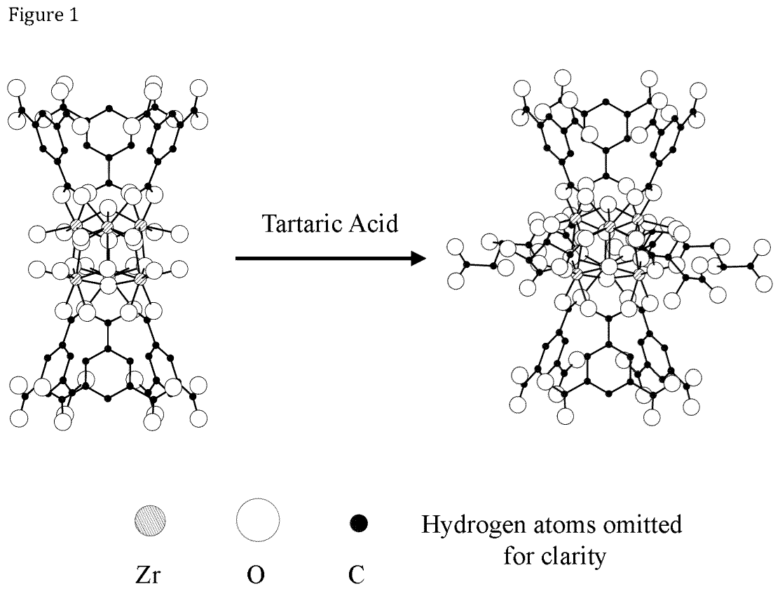

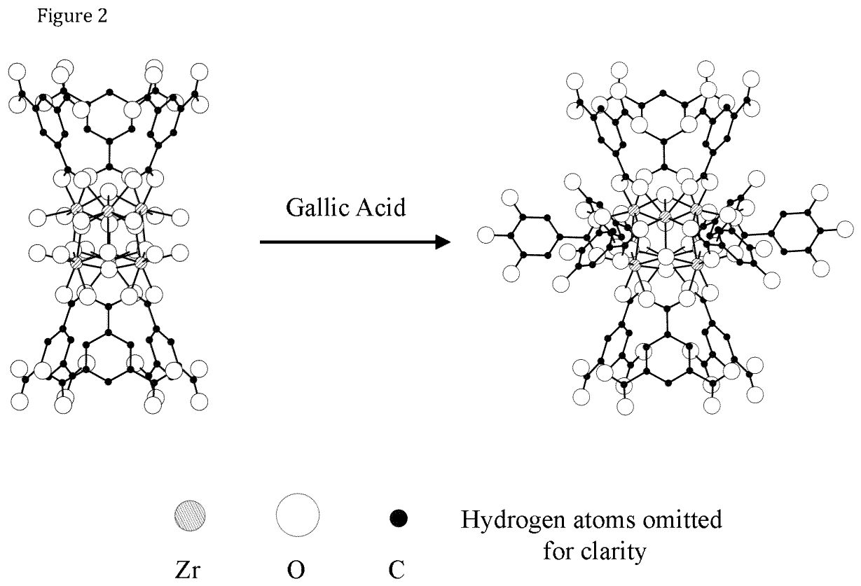

Metal-organic framework compositions of the instant invention further comprise a plurality of organic ligands wherein each organic ligand comprises a coordination group and at least one functional group. Preferably, the organic ligand may comprise at least two functional groups. Organic ligands are organic molecules comprising a coordination group selected from one or more of carboxylate, phosphonate, phosphonite, sulfonate, and sulfinate. The organic ligand binds to coordination sites on the metal node through the coordination group, thereby providing a ligand-modified MOF, also referred to as a decorated MOF. Examples of an organic ligand binding through a coordination group to an open coordination site are shown in FIG. 1 and FIG. 2. In FIG. 1, as-synthesized MOF-808 is decorated with tartaric acid wherein tartaric acid binds to Zr—OH groups on the metal node through a carboxylate group on the tartaric acid. In FIG. 2, as-synthesized MOF-808 is decorated with gallic acid wherein gallic acid binds to Zr—OH groups on the metal node through the carboxylate group on the gallic acid. Typically, each coordination group on an organic ligand may bind to one coordination site on a MOF. The organic ligand may be present in the range from at least about 0.1 molar equivalent of ligand per metal node to up to about 11 molar equivalents of ligand per metal node. The organic ligand may be present in the range from at least about 0.25 molar equivalent of ligand per metal node to up to about 8 molar equivalents of ligand per metal node; or from at least about 0.5 molar equivalents of ligand per metal node to up to about 6 molar equivalents of ligand per metal node; or at least about 0.75 molar equivalents of ligand per metal node to up to about 5 molar equivalents of ligand per metal node; or at least about 1.0 molar equivalents of ligand per metal node up to about 5 molar equivalents of organic ligand per metal node; or combinations thereof.

The organic ligand further comprises at least one functional group. Functional groups may be selected from one or more of hydroxyl, amine, amino, carboxylate, sulfonate, and phosphonate or combinations thereof. Where two or more functional groups are present on the organic ligand, then at least two functional groups on the organic ligand may be vicinal. The organic ligand may be aromatic. The organic ligand may be aliphatic. The desired organic ligand may vary according to the adsorbent properties desired. For clarity, tartaric acid is aliphatic and comprises a carboxylate coordination group, two hydroxyl functional groups and a carboxylate functional group. The hydroxyl groups are vicinal on the aliphatic backbone. For clarity, gallic acid is aromatic and comprises a carboxylate coordination group and three hydroxyl functional groups vicinal to one another on the phenyl ring.

In an aspect, the organic ligand may be selected from one or more of tiron (disodium 4,5-dihydroxy-1,3-benzenedisulfonate), gallic acid, 5-sulfosalicylic acid, tartaric acid, 3,4-diaminobenzoic acid, 3,5-diaminobenzoic acid, citric acid, 3-amino-4-hydroxybenzenesulfonic acid, 3,4-dihydroxybenzoic acid, 3,5-dihydroxybenzoic acid, 4-amino-3-hydroxybenzoic acid, 2-aminoterephthalic acid, 2,3-dihydroterephthalic acid, 2,5-dihydroterephthalic acid, pyridine-2,3-dicarboxylic acid, pyridine-2,4-dicarboxylic acid, pyridine-2,5-dicarboxylic acid, pyrazine-2,3-dicarboxylic acid, pyrazine-2,5-dicarboxylic acid, and pyrimidine-4,6-dicarboxylic acid. In an aspect, the organic ligand may be selected from one or more of tiron (disodium 4,5-dihydroxy-1,3-benzenedisulfonate), gallic acid, 5-sulfosalicylic acid, tartaric acid, 3,4-diaminobenzoic acid, 3,5-diaminobenzoic acid, citric acid, and 3-amino-4-hydroxybenzenesulfonic acid.

Another aspect of the composition of the MOFs disclosed herein is a metal (M′) salt interacting with the framework. The M′ metal includes but is not limited to Li, Na, K, Mg, Ca, Sr, Ba, Ti, Sc, Y, Ti, Zr, Hf, V, Cr, Mo, W, Fe, Co, Ni, Cu, Ag, Zn, Cd, Al, Ga, In, Sn, Pb, and mixtures thereof. The M′ metal is present as the metal salt and is impregnated onto the surface of the MOF or in the pores of the MOF, or both. Therein, the metal salt is said to be interacting with the MOF framework to form the disclosed MOF composition. Without being bound by theory, it is believed that the metal salt may be bound to the functional group or groups of the organic ligand. In an embodiment, the metal salt may be bound to vicinal functional groups on a single organic ligand.

The metal salt may be a Lewis acid. The metal salt may be selected from a halide, sulfate, carbonate, acetate, carboxylate, sulfonate, nitrate, or mixtures thereof. The metal salt may be selected from the group of metal acetates or metal nitrates or metal halides or a combination thereof. The metal salt may be a metal halide or a combination of metal halides. The metal salt may be selected from one or more of Li(C2H3O2), Li(NO3), LiCl, Na(C2H3O2), Na(NO3), NaCl, K(C2H3O2), K(NO3), KCl, Mg(C2H3O2)2, Mg(NO3)2, MgCl2, Ca(C2H3O2)2, Ca(NO3)2, CaCl2, Ba(C2H3O2)2, Ba(NO3)2, BaCl2, Ti(O)(NO3)2, Ti(O)(Cl)2,TiCl4, ScCl3, YCl3, Zr(O)(NO3)2, Zr(O)(Cl)2, ZrCl4, HfCl4, VOCl3, VCl3, FeCl3, CoCl2, Co(C2H3O2)2, NiCl2, Ni(C2H3O2)2, CuCl2, Cu(C2H3O2)2, FeCl3, AgCl, ZnCl2, AlCl3, GaCl3, and InCl3. The metal salt may be selected from one or more of NiCl2, ZnCl2, CuCl2, and FeCl3.

The M and M′ metals can be the same or can be different. It is preferred that the M′ metal be different from the M metal. The amount of metal salt impregnated on the MOF can vary considerably but is usually from about 1 wt % to about 70 wt. %, or from about 5 wt. % to about 65 wt. % or from about 10 wt. % to about 60 wt. % or from about 15 wt. % to about 55 wt. % or from about 20 wt. % to about 50 wt. % or from about 25 wt. % to about 45 wt. % as the metal.

Another aspect of the invention is a process for preparing the MOF composition, comprising synthesizing an initial metal-organic framework comprising a plurality of metal nodes each having at least two coordination sites wherein said metal nodes are connected by a plurality of organic linkers bound at one or more coordination sites on said metal nodes to form an initial metal-organic framework; contacting the initial MOF with a first solution comprising an organic ligand and a ligand incorporation solvent to form a ligand-modified MOF; and contacting the ligand-modified MOF with a second solution comprising a metal salt and a salt impregnation solvent to form a MOF composition. The MOF composition is then separated from the solution and optionally activated.

The initial step of the synthesis involves preparing an initial MOF by synthetic techniques known in the literature, including without limitation solvothermal techniques. Typically, a solution of the desired metal node and the organic linker is prepared. The metal M may be introduced as a metal salt. The salt can be the nitrate, halide, sulfate, carbonate etc. Specific examples of salts which can be used include but are not limited to zirconium oxynitrate, zirconium oxychloride, zirconium sulfate, hafnium oxynitrate, hafnium oxychloride, vanadium chloride, copper sulfate, iron chloride, zinc nitrate, or zinc carbonate.

The linker to be used can be an organic linker which are organic molecules comprising at least two groups which can bind to the metal nodes, such as carboxylate functionalities. The linker may be added in molar ratios to arrive at the molar ratios desired in the initial MOF.

Once the reaction mixture is formed, i.e. all reactants are solubilized, the reaction mixture is reacted at a temperature and time to form the desired initial MOF. Reaction temperature can vary from about 500C to about 2000 C, or from about 750C to about 1250C. The reaction mixture is reacted at the desired temperature for a time selected from about 1 hr. to about 78 hr. or from about 8 hr. to about 48 hr. or from about 12 hr. to about 24 hr. Once the initial MOF is formed, it may be isolated by means such as filtration, centrifugation, etc. The wet initial MOF may optionally be dried at room temperature or at a temperature of about 400C to about 2500C or a temperature from about 750C to about 1500C. The time for drying the wet initial MOF can vary substantially but is usually from about 2 hr. to about 14 days or from about 8 hr. to about 7 days or from about 2 days to about 7 days.

The thus isolated initial MOF may then be contacted with a first solution comprising an organic ligand and a ligand incorporation solvent. The organic ligand may be dissolved in a ligand incorporation solvent including without limitation alcohols, amides, organic acids, sulfoxides, sulfones, water, acetone, ethers, and mixtures thereof. Specific examples of suitable ligand incorporation solvents include without limitation MeOH, H₂O, DMF, acetic acid, trifluoroacetic acid, formic acid, dimethyl acetamide, sulfolane, propylene glycol, ethylene glycol, DMSO, HCl, and combinations of any of the foregoing. The ligand incorporation solvent may possess a high dielectric constant. The relative permittivity of the ligand incorporation solvent may be greater than about 15. The molar ratio of the organic ligand to the initial MOF may also be adjusted such that the specific molar ratio of ligand to the MOF is achieved. The first solution may be contacted with the MOF for a time from about 1 min to about 24 hours at a temperature from about room temperature to about 100° C. or to about 65° C. The product is a ligand-modified MOF, also referred to herein as a ligand incorporated MOF or a “decorated” MOF.

In an alternative embodiment in a one-pot preparation the initial MOF may be functionalized with the organic ligand without first being subjected to separation and drying steps.

The ligand incorporated MOF may optionally be dried or activated. The wet ligand incorporated MOF may be dried at room temperature or at a temperature of about 400C to about 2500C or a temperature from about 750C to about 1500C or a temperature from about 1000C to about 1250C to dry the MOF. The time for drying the wet ligand incorporated MOF can vary substantially but if performed is usually from about 2 hr. to about 14 days or from about 8 hr. to about 7 days or from about 2 days to about 7 days. Optionally, the dried MOF can be activated such as by passing hot N2 gas over the MOF or by applying a vacuum, with or without heating.

The ligand-modified MOF may then be contacted with a second solution comprising a metal salt and a salt impregnation solvent. The salt impregnation solvent may possess a high dielectric constant. The relative permittivity of the salt impregnation solvent may be greater than about 15. The salt impregnation solvent may include but is not limited to alcohols, amides, water, acetone, ethers, and mixtures thereof. In one embodiment the salt impregnation solvent may be selected from H₂O, aliphatic alcohols, acetone, DMF, and mixtures thereof. The molar ratio of the metal salt to the ligand-modified MOF may also be adjusted such that the specific molar ratio of salt to the MOF is achieved. The contacting of the ligand-modified MOF with the second solution may be carried out by impregnation techniques, thereby impregnating the metal salt onto the MOF.

In a first method of salt impregnation, the ligand-modified MOF is first activated, then a volume of second solution is added which may be equal to the total pore volume of the MOF being used. This is usually referred to as an incipient wetness impregnation. The second solution may be contacted with the MOF for a time from about 1 min to about 24 hours at a temperature from about room temperature to about 65 0C. The impregnated MOF composition may then be activated. In one exemplary process of this first method, a 40 mL vial is loaded with 5 g of activated MOF powder, then a 2-6 M metal salt (ZnCl2, FeCl3, CuCl2, NiCl2, etc.) solution (e.g. MeOH, H₂O, acetone, etc.) is added slowly with mixing until the solid no longer remains dry after addition. Generally, a 4 M solution in methanol is suitable for impregnation. The volume of solution added is generally the volume by mass of the pore, such as may be obtained by an isotherm. The resulting solid can be dried, such as at 150° C. overnight in a vacuum oven.

In a second method of salt impregnation, the contacting of the MOF with the second solution may comprise contacting a ligand-modified MOF in either an activated form or an unactivated from with the second solution which may be recirculated or allowed to soak without recirculation. The contacting can vary substantially in time but it usually occurs from about 1 hr. to about 5 days or about 3 hrs. to about 2 days or about 8 hrs. to about 24 hrs. The salt impregnated ligand-modified MOF may then be separated from the second solution by filtering, centrifugation, etc. The salt impregnated ligand-modified MOF may be dried or activated using the conditions described above. In one exemplary process of this second method, to a 40 mL vial are added 5 g of unactivated MOF powder, then a 2-6 M metal salt (ZnCl2, FeCl3, CuCl2, NiCl2, etc.) solution (e.g. MeOH, H₂O, acetone, etc.) is added until the solid is completely submerged and allowed to come to equilibrium overnight. Generally, a 4 M solution in methanol is suitable for impregnation. The volume added is generally 1:5 mass of MOF: volume of solution. The slurry can be filtered, and the resulting solid can be dried at 150° C. overnight in a vacuum oven.

The method of manufacturing the MOF composition may further comprise forming the product with or without a binding agent. Although the material comprising a MOF composition can be formed into various shapes as discussed below, a particular process involves preparing granules. Binders which can be used include both organic and inorganic binders. Examples of inorganic binders include but are not limited to clays such as kaolin, attapulgite, and boehmite, aluminas, silicas, metal oxides, and mixtures thereof. Specific examples of organic binders include but are not limited to polymers, e.g. polyvinylpyrrolidone (PVP), starches, gelatin, carbon, cellulose, cellulose derivatives, sucrose, polyethylene glycol, and mixtures thereof.

The granulation can occur before, during, or after the salt impregnation. In one embodiment, a dried powder of the MOF composition comprising the coordinated ligand and the metal salt is mixed with a binder and the combination mixed thoroughly. In one embodiment, the ligand-modified MOF and binder are first thoroughly mixed and then the second solution containing the desired metal (M′) salt is admixed with the MOF/binder mixture to provide a material comprising the impregnated MOF with binder. In either embodiment of the method the MOF-binder mixture can be mixed for a time from about 1 min to about 5 min until granules of a desired size are obtained. It is understood that a range of sizes is always obtained, and the granules thus need to be sized, i.e. sieved, to isolate the granules having the desired size or size range. The size range of the granules will depend on the specific use of the final composition comprising a MOF and will depend on various parameters such as pressure drop, packing density, etc. Granules may have an average diameter from about 1680 microns (12 mesh) to about 250 microns (60 mesh) or from about 1190 microns (16 mesh) to about 841 microns (20 mesh) or from about 841 microns (20 mesh) to about 400 microns (40 mesh) or from about 595 microns (30 mesh) to about 297 microns (50 mesh) are desired. By average diameter is meant the average diameter assuming an approximate spherical shape. This does not mean that the granules are actually spherical but that they will go through a mesh sieve of a given diameter. Once the desired size granules are obtained, they are dried at a temperature of about 500C to about 2500C or about 1000C to about 2500C under vacuum for a time necessary to reach a pressure of about 13.3 Pa (0.1 torr) to activate the MOF composition. The composition can also be heated under a flow of a hot gas such as hot nitrogen to activate the MOF composition.

The MOF compositions disclosed herein may be characterized by the following properties. One property is that it may have a static ammonia capacity measured at 1333 Pa (10 Torr) and 25° C. of at least 4 mmol/g or at least 6 mmol/g or at least 8 mmol/g or at least 10 mmol/g or at least 12 mmol/g or at least 15 mmol/g or at least 20 mmol/g or at least 25 mmol/g. One property of the MOF compositions may be a Brunauer-Emmett-Teller (BET) surface area of at least 200, or at least 400, or at least 700, or at least 1200, or at least 2000 m²/g as measured by N2 adsorption.

Materials comprising a MOF composition as disclosed herein may be used to capture a target chemical in a fluid stream, wherein a solid adsorbent composition comprising a MOF composition as disclosed herein is contacted with a fluid stream comprising a target chemical and at least some of said target chemical is adsorbed by said solid adsorbent. The fluid stream may be a gas stream wherein a solid adsorbent composition comprising a MOF composition is contacted with a gas stream comprising a target chemical and at least some of said target chemical is adsorbed by said solid adsorbent.

Gas streams which may need to be purified include but are not limited to air streams, industrial gas streams, off-gassing streams, or pollutant gas streams. In one embodiment the gas stream is an air stream. The MOF compositions disclosed herein can be prepared with selected metal nodes, organic linkers, organic ligands, and metal salts to be suited for removing particular acidic and/or basic target chemicals from an air stream. Target chemicals to be removed by the MOF compositions of the disclosure may comprise toxic industrial chemicals or chemical warfare agents (CWA) or combinations thereof. Target chemicals which may be removed by the MOF compositions, include but are not limited to ammonia, bromine, boron tribromide, bromine chloride, boron trichloride, bromine trifluoride, bromine pentafluoride, carbonyl fluoride, chlorine, chlorine pentafluoride, chlorine trifluoride, chlorosulfonic acid, dichlorosilane, ethyl phosphonous dichloride, fluorine, hydrogen bromide, hydrogen chloride, hydrogen cyanide, hydrogen fluoride, hydrogen iodide, nitric acid, nitrogen dioxide, nitrogen tetroxide, nitrogen trioxide, phosgene, phosphorus trichloride, silicon tetrafluoride, sulfuric acid, sulfuryl chloride, titanium tetrachloride, tungsten hexafluoride, and mixtures thereof. In an embodiment, MOF compositions as disclosed herein may remove both basic and acidic target chemicals, e.g. TICs, in a gas stream.

In one embodiment, the target chemical to be removed by adsorption may include ammonia. The ammonia in the gas stream may be present in a concentration of from about 1 ppb to about 10%. The ammonia concentration in the gas stream may range from greater than about 1 ppb, or about 10 ppb, or about 100 ppb, or about 1 ppm, or about 10 ppm, or about 100 ppm, or about 1%; and may be less than about 10 wt %, or about 5 wt %, or about 1 wt %, or about 100 ppm.

The amount of target chemical (acidic or basic) which the MOF composition can remove may be at least 50% or at least 60%, or at least 70%, or at least 80%, or at least 90% or at least 95%, or at least 99% of the target chemicals. In one embodiment, the gas stream is an air stream, the target chemicals are NO2, and/or ammonia and the MOF composition removes at least 80% of the NO2 or at least 80% of the ammonia in the air stream. In another embodiment, a vessel, having an inlet and outlet port, is filled with a material comprising a MOF composition through which the gas stream is flowed thereby substantially removing at least one basic target chemical, or at least one acidic target chemical, or at least one basic target chemical and one acidic target chemical, from the stream. In order to achieve the desired removal amount, the gas stream may be flowed through the MOF composition at a rate of about 0.1 L/min to about 500 L/min or a rate from about 10 L/min to about 400 L/min or a rate from about 30 L/min to about 200 L/min or a rate of about 50 L/min to about 120 L/min.

Although the material comprising a MOF composition can be used in the powder form, it may be advantageous to form the material comprising a MOF composition into various shaped bodies such as pellets, spheres, disks, monolithic bodies, irregularly shaped particles and extrudates. The methods of forming these types of shapes are well known in the art. A particular method of forming granular materials is set forth above. The material comprising a MOF composition can be formed into various shapes by themselves or by including a binder. When selecting a binder, it is important to select a binder such that the surface area and adsorption capacity is not adversely affected once the desired shaped body is formed.

The forming process usually involves preparing a thick paste-like material by mixing a MOF composition with a solvent or a binder plus a solvent. Once the paste-like material is formed it can be extruded through a die having holes of about 1-4 mm to form extrudates of varying length, e.g. 2-50 mm. The paste or even the powder itself can be pressed at high pressure to form pellets or pills. Other means of forming shapes include pressure molding, metal forming, pelletizing, granulation, extrusion, rolling methods and marmorizing.

In yet another aspect, the MOF composition with or without binder can be deposited onto articles such as, but not limited to, monoliths, spherical supports, ceramic foams, glass fibers, woven fabrics, nonwoven fabrics, membranes, pellets, extrudates, irregularly shaped particles, and mixtures thereof. When the desired article is a monolith, spherical support, ceramic foam, pellets, extrudates, or irregularly shaped particles, a slurry of the composition comprising a MOF composition is prepared and deposited on the article by means such as dipping, spray drying, etc. followed by drying and optionally calcination. The MOF compositions can be deposited or dispersed onto fabrics (woven and non-woven) or polymers by techniques such as electro-spinning, direct crystal growth, and layer by layer deposition.

Articles comprising a material comprising a MOF composition as described in the previous paragraphs can be used to purify air or other gas streams containing target chemicals. The air or other gas streams can be flowed through the article, e.g. monolith, foam, membranes, fabrics whereby the MOF composition will adsorb at least a portion of the at least one target chemical. The articles comprising a MOF composition can also be placed in various types of rigid containers. For example, extrudates or pills or spheres can be housed in a bed through which the air or other gas stream is flowed through. The bed can be placed in various types of housings such as filter canisters having an inlet and outlet. Fabrics (both woven and non-woven) can also be formed into filters such as but not limited to pleated filters which again can be housed in rigid containers such as cartridges through which the stream to be treated flows through. In one particular embodiment the cartridges are part of a face mask. Pleated filters can also be supported in various shaped and sized frames and the gas stream flowed through it. The frames can be made of various types of materials such as but not limited to metal, wood and plastic. Fiber glass can be formed into glass wool and housed in rigid filter frames.

An article comprising a material comprising a MOF composition as disclosed herein further can be in the form of an assembly or apparatus which comprises a plurality of layers or a non-layered mixture of particles through which a gas stream, e.g. air stream is flowed through. In a particular embodiment, the first layer which contacts the gas stream is the material comprising a MOF composition, and the second layer contains activated carbon. Additional layers may be added as needed, for example a hopcalite layer. For example, layers of two different MOF compositions can be used. Alternatively, two or more MOF compositions can be mixed and form one layer. These layers can be arranged in a bed which can be housed in a rigid structure such as a canister, e.g. or a larger vessel if a large gas stream is to be purified, e.g. air stream entering a commercial building. As stated above the MOF composition in the layer can be in the form of a powder or a material comprising a MOF composition can be in any of the shapes and forms described above.

Activated carbons which can be used as a layer as described above are highly porous, high surface area adsorptive materials with a largely amorphous structure. They are composed primarily of aromatic configurations of carbon atoms joined by random cross-linkages. The degree of order varies based on the starting raw material and thermal history. Graphitic platelets in steam-activated coal are somewhat ordered, while more amorphous aromatic structures are found in chemically activated wood. Randomized bonding creates a highly porous structure with numerous cracks, crevices and voids between the carbon layers. Activated carbons may be in the form of powder (PAC), granule (GAC) or extrudate (EAC). All three forms are available in a range of particle sizes.

When the material comprising a MOF composition and activated carbon are deposited on fabrics (woven or nonwoven), the fabrics can be arranged as layers of a face mask or other filtering apparatus.

A pleated sheet can be formed which comprises layers of activated carbon and composition comprising a MOFs. The pleated sheets can be formed into various arrangements such as filter canisters or be housed in a rigid container such as a frame which can be made of various materials such as plastic, wood, metal, cardboard, etc.

### EXAMPLES

### Example 1: Synthesis of Zr(BTC)

Zr(BTC), also known as MOF-808, was prepared using a scaled-up literature procedure. (ref: Chem. Mater. 2021, 33, 4, 1471-1476) Generally, the procedure involved adding the BTC linker (21.7 g, 0.33 eq.) in a 2-L flask with an overhead stirrer. To the flask, water (330 mL) was added, followed by acetic acid (880 mL). The solution was heated to a temperature of about 100° C., adding ZrOCl₂ 8H₂O (117 g, 1 eq.) and reacting for 18 hrs. to provide the MOF. The MOF powder was isolated via filtration or centrifuge and washed with water and methanol. This material (Example 10) was moved onto Example 2 or granulated in Example 3 to yield Control 1.

### Example 2: Incorporation of Organic Ligand

The MOF of Example 1 (60 g, 43 mmol), 10 molar equivalents of organic ligand, and methanol (800 mL) were placed into 1-L round bottom flask with a stir bar. The reaction was stirred at 60° C. overnight. The reaction product was filtered and washed 3× with methanol. The material was used without further purification. This method was used to prepare the ligand-incorporated MOFs of Table 1. The characterization of equivalents of ligand was done by NMR as described in Example 8.

### Example 3: Granulation

To a pan mixer, 150 g of unactivated MOF (unmodified from Example 1 or ligand-modified from Example 2) was added along with a colloidal silica solution (5 wt % SiO2 dry basis) and the mixture was thoroughly mixed. Water was added and continued to be mixed until granules formed. The granules were sieved and the desired size granules were separated. The resulting solid was activated at 150° C. in a vacuum oven until a dynamic pressure (<0.1 Torr) was reached.

Control 1 is herein Example 10 above granulated by procedure of this Example 3 and Examples 3A-3E herein are Examples 2A-2E above granulated by the procedure of this Example 3.

TABLE 1

| | | | | Eq of | Eq of |
|---|---|---|---|---|---|
| | | | | Ligand | Ligand |
| Example | Base | | | per | per |
| No. | MOF | Zr/node | Ligand | Zr | Node |
| 3A | Zr(BTC) | 6 | Gallic Acid | 0.5 | 2.8 |
| 3B | Zr(BTC) | 6 | Citric Acid | 0.9 | 5.2 |
| 3C | Zr(BTC) | 6 | 5-sulfosalicylic | 0.5 | 3.3 |
| | | | acid | | |
| 3D | Zr(BTC) | 6 | Tiron | 0.5 | 2.9 |
| 3E | Zr(BTC) | 6 | Tartaric Acid | 0.5 | 3.0 |

### Example 4: Impregnation of Granulated Ligand-Modified MOF

For each of the activated granulated MOFs of Example 3A-3E synthesized above, in a 40 mL vial, there were added 5 g of the granulated product. To the granulated product a metal salt solution in methanol was added until the solid was completely submerged and was allowed to come to equilibrium overnight. The volume added was generally 1:5 mass of MOF: volume of solution. The slurry was filtered, and the resulting solid was dried at 150° C. overnight in a vacuum oven.

Control 2: Control 1 was impregnated with 2.5 M ZnCl2 solution.

Control 3: Control 1 was impregnated with 4.0 M ZnCl2 solution.

Control 4: Control 1 was impregnated with 4.125 M MgCl2 solution.

Control 5: Control 1 was impregnated with 5.0 M FeCl3 solution.

Control 6: Control 1 was impregnated with 4.125 M CuCl2 solution.

Control 7: Control 1 was impregnated with 4.125 M NiCl2 solution.

Example 4A1: MOF of Example 3A was impregnated with 2.5 M ZnCl2 solution.

Example 4A2: MOF of Example 3A was impregnated with 4.0 M CuCl2 solution.

Example 4A3: MOF of Example 3A was impregnated with 4.0 M FeCl3 solution.

Example 4A4: MOF of Example 3A was impregnated with 4.0 M ZnCl2 solution.

Example 4A5: MOF of Example 3A was impregnated with 4.125 M MgCl2 solution.

Example 4A6: MOF of Example 3A was impregnated with 5.0 M FeCl3 solution.

Example 4A7: MOF of Example 3A was impregnated with 4.125 M CuCl2 solution.

Example 4A8: MOF of Example 3A was impregnated with 4.125 M NiCl2 solution.

Example 4B1: MOF of Example 3B was impregnated with 4.0 M ZnCl2 solution.

Example 4B2: MOF of Example 3B was impregnated with 4.125 M MgCl2 solution.

Example 4B3: MOF of Example 3B was impregnated with 5.0 M FeCl3 solution.

Example 4B4: MOF of Example 3B was impregnated with 4.125 M CuCl2 solution.

Example 4B5: MOF of Example 3B was impregnated with 4.125 M NiCl2 solution.

Example 4C1: MOF of Example 3C was impregnated with 4.0 M ZnCl2 solution.

Example 4C2: MOF of Example 3C was impregnated with 4.125 M MgCl2 solution.

Example 4C3: MOF of Example 3C was impregnated with 4.125 M CuCl2 solution.

Example 4C4: MOF of Example 3C was impregnated with 4.125 M NiCl2 solution.

Example 4D1: MOF of Example 3D was impregnated with 4.0 M ZnCl2 solution.

Example 4D2: MOF of Example 3D was impregnated with 4.125 M MgCl2 solution.

Example 4D3: MOF of Example 3D was impregnated with 5.0 M FeCl3 solution.

Example 4D4: MOF of Example 3D was impregnated with 4.125 M CuCl2 solution.

Example 4D5: MOF of Example 3D was impregnated with 4.125 M NiCl2 solution.

Example 4E1: MOF of Example 3E was impregnated with 4.0 M CuCl2 solution.

Example 4E2: MOF of Example 3E was impregnated with 4.0 M FeCl3 solution.

Example 4E3: MOF of Example 3E was impregnated with 4.0 M ZnCl2 solution.

Example 4E4: MOF of Example 3E was impregnated with 4.125 M MgCl2 solution.

Example 4E5: MOF of Example 3E was impregnated with 5.0 M FeCl3 solution.

Example 4E6: MOF of Example 3E was impregnated with 4.125 M CuCl2 solution.

Example 4E7: MOF of Example 3E was impregnated with 4.125 M NiCl2 solution.

### Example 5: Synthesis of Ligand Modified Zr(BDC-NH2)

Step 1. Zr(BDC-NH2), also known as UiO-66-NH2, was prepared using literature procedures. Generally, the procedure involved charging the BDC-NH2 to a 2-L flask with an overhead stirrer. To the flask, DMF (440 mL) was added, followed by formic acid (440 mL). The solution was heated to a temperature of about 90° C., the ZrOCl2 was added and the solution was reacted for 18 hrs. to provide the MOF. The MOF powder was isolated, then washed with DMF and acetone.

Step 2. The MOF obtained in Step 1 above was stirred at 60° C. in 1 N HCl (2 L) for 12 hrs. The resulting solid was washed with water 3×. This material (Example 50) was moved onto step 3 or granulated in Example 6 to yield Control 8.

Step 3. The thus HCl treated MOF (50 g, 28.5 mmol), 10 molar equivalents of organic ligand, and methanol (800 mL) were placed into 1-L round bottom flask with a stir bar. The reaction was stirred at 60° C. overnight. The reaction was filtered and washed 3× with methanol. The characterization of ligand equivalents was done by NMR as described in Example 8.

### Example 6: Granulation

To a pan mixer, 150 g of unactivated MOF of (unmodified after step 2 in Example 5 or ligand-modified after step 3 in Example 5) was added along a colloidal silica solution (5 wt % SiO2 dry basis) and the mixture thoroughly mixed. Water was added until and continued to be mixed until granules formed. The granules were sieved, and the desired size granules were separated.

Control 8 is herein Example 50 above granulated by procedure of this Example 6 and Examples 6A-6D herein are Examples 5A-5D above granulated by the procedure of this Example 6.

TABLE 2

| | | | | Eq of | Eq of |
|---|---|---|---|---|---|
| Example | Base | | | Ligand per | Ligand per |
| No. | MOF | Zr/Node | Ligand | Zr | Node |
| 6A | Zr(BDC- | 12 | Citric acid | 0.4 | 5.1 |
| | NH₂) | | | | |
| 6B | Zr(BDC- | 12 | Gallic Acid | 0.4 | 4.5 |
| | NH₂) | | | | |
| 6C | Zr(BDC- | 12 | Tartaric Acid | 0.2 | 2.7 |
| | NH₂) | | | | |
| 6D | Zr(BDC- | 12 | 3-Amino-4- | 0.3 | 3.8 |
| | NH₂) | | hydroxybenzenesulfonic acid | | |

### Example 7: Metal Salt Impregnation

For each of the activated granulated MOFs of Example 6A-6D synthesized above, in a 40 mL vial, there were added 5 g of the granulated product. To the granulated product a 1.25-1.5 M ZnCl2 aqueous solution was added until the solid was completely submerged and was allowed to come to equilibrium overnight. The volume added was generally 1:5 mass of MOF: volume of solution. The granules were filtered, and the resulting solid was dried at 100° C. overnight in a vacuum oven until a dynamic pressure (<0.1 Torr) was reached.

Control 9: Control 8 was impregnated with 1.5 M ZnCl2 solution.

Control 10: Control 8 was impregnated with 1.5 M MgCl2 solution.

Control 11: Control 8 was impregnated with 1.5 M FeCl3 solution.

Control 12: Control 8 was impregnated with 1.5 M CuCl2 solution.

Control 13: Control 8 was impregnated with 1.5 M NiCl2 solution.

Example 7A1: MOF of Example 6A was impregnated with 1.5 M ZnCl2 solution.

Example 7A2: MOF of Example 6A was impregnated with 1.5 M MgCl2 solution.

Example 7A3: MOF of Example 6A was impregnated with 1.5 M FeCl3 solution.

Example 7A4: MOF of Example 6A was impregnated with 1.5 M CuCl2 solution.

Example 7A5: MOF of Example 6A was impregnated with 1.5 M NiCl2 solution.

Example 7B1: MOF of Example 6B was impregnated with 1.5 M ZnCl2 solution.

Example 7B2: MOF of Example 6B was impregnated with 1.5 M MgCl2 solution.

Example 7B3: MOF of Example 6B was impregnated with 1.5 M FeCl3 solution.

Example 7B4: MOF of Example 6B was impregnated with 1.5 M CuCl2 solution.

Example 7B5: MOF of Example 6B was impregnated with 1.5 M NiCl2 solution.

Example 7C1: MOF of Example 6C was impregnated with 1.5 M ZnCl2 solution.

Example 7D1: MOF of Example 6D was impregnated with 1.25 M ZnCl2 solution.

Example 7D2: MOF of Example 6D was impregnated with 1.5 M MgCl2 solution.

Example 7D3: MOF of Example 6D was impregnated with 1.5 M FeCl3 solution.

Example 7D4: MOF of Example 6D was impregnated with 1.5 M CuCl2 solution.

Example 7D5: MOF of Example 6D was impregnated with 1.5 M NiCl2 solution.

### Example 8: Characterization Methods and Breakthrough Testing

Nuclear Magnetic Resonance (NMR) samples were prepared through normal literature techniques. The ligand modified MOF was digested in 1 M NaOH in D20 for 10 min. The ligands were measured using quantitative NMR vs the linker. The theoretical linker to zirconium ratio (6 Zr per node in Zr(BTC) and 12 per node in Zr(BDC-NH2)) in the corresponding MOF was used to determine the ligand to node ratio.

All ammonia adsorption and desorption measurements were performed at 25° C. on a Micromeritics 3Flex Surface Characterization Analyzer (Micromeritics, Norcross Ga.) by dosing to an absolute pressure and using a 3 second equilibration interval.

In the following Examples, all N2 gas adsorption and desorption measurements, unless stated otherwise, were performed on the Micromeritics Tristar II 3020 system (Micromeritics, Norcross, Ga.) at 77 K. Between 75-200 mg of samples were employed in each measurement. The specific surface areas for N2 were calculated using the Brunauer-Emmet Teller (BET) model in the range of 0.005<P/P0<0.05. The N2 uptakes were measured at P/P0=0.9, where P/P0 is the measured pressure relative to atmospheric pressure.

### Breakthrough Testing

A fixed volume of material of the above Examples (1.0 cm in a 40 mm tube) was packed into a breakthrough system. After a nitrogen purge, a stream containing ammonia in air was introduced and flowed through the MOF at 12.4 cm/s. When the exit concentration measured 5% of the original gas stream, the breakthrough time was recorded. Sample details and results are stated in Table 3. The data is reported in concentration time (Ct), which is determined by the concentration of the gas (e.g. NH3) and the length of exposure (in minutes) before breakthrough.

The results above show that compositions comprising a MOF comprising a plurality of metal nodes each having at least two coordination sites, a plurality of organic linkers, wherein the metal nodes are connected by the organic linkers bound at one or more coordination sites on the metal nodes to form a metal-organic framework; a plurality of organic ligands each comprising a coordination group bound to a coordination site of a metal node, each organic ligand having at least one functional group; and a metal salt interacting with the framework are highly effective for removing target chemicals from gas streams.

Specifically, for Zr(BTC) decorated with gallic acid, it may be seen that each of Table 3 entries 9-16 which include impregnated metal salt have higher ammonia uptake and longer ammonia breakthrough times than Table 3 entry 8 which is the non-salt impregnated version. Comparing entries 17-22 for Zr(BTC) decorated with citric acid, entries 18-22 which include impregnated metal salt have a higher ammonia uptake and longer ammonia breakthrough time than Table 3 entry 17 which is the non-salt impregnated version. Comparing entries 23-27 for Zr(BTC) decorated with 5-sulfosalicylic acid, entries 24-27 which include impregnated metal salt have a higher ammonia uptake and longer ammonia breakthrough time than Table 3 entry 23 which is the non-salt impregnated version.

TABLE 3
Zr(BTC-X) and Zr(BDC-NH₂) Metal Impregnation, NH₃ Uptake (mmol/g
at 25° C. and 10 Torr), and Breakthrough Data (Ct in mg-min/m³)

| | | | | | | | NH₃ | | | |
|---|---|---|---|---|---|---|---|---|---|---|
| | | | | | | % wt | Uptake | N₂ | | |
| | | | | | [Impreg- | MClx | (mmol/g | Uptake | BET | Ct |
| | Example | Base | | Metal | nate] | after | @ 10 | (cm³/g | Area | (mg-min/ |
| Entry | # | MOF | Ligand | Impreg | (M) | Impreg | Torr) | STP) | (m²/g) | m³) |
| 1 | Control 1 | Zr(BTC) | — | — | — | — | 5.4 | 446 | 1949 | 18835 |
| 2 | Control 2 | Zr(BTC) | — | ZnCl₂ | 2.5 | 31% | 6.4 | 261 | 1151 | 41572 |
| 3 | Control 3 | Zr(BTC) | — | ZnCl₂ | 4 | 35% | 8.5 | 211 | 895 | 66129 |
| 4 | Control 4 | Zr(BTC) | — | MgCl₂ | 4.125 | 32% | 5.65 | 166.31 | 899 | 44203 |
| 5 | Control 5 | Zr(BTC) | — | FeCl₃ | 5 | 46% | 6.27 | 125.44 | 503 | 68002 |
| 6 | Control 6 | Zr(BTC) | — | CuCl₂ | 4.125 | 40% | 9.06 | 120.86 | 680 | 78803 |
| 7 | Control 7 | Zr(BTC) | — | NiCl₂ | 4.125 | 36% | 10.7 | 164.59 | 677 | 117217 |
| 8 | 3A | Zr(BTC) | Gallic acid | — | — | — | 5.2 | 401 | 1457 | 32538 |
| 9 | 4A1 | Zr(BTC) | Gallic acid | ZnCl₂ | 2.5 | 31% | 7.8 | 185 | 566 | 75536 |
| 10 | 4A2 | Zr(BTC) | Gallic acid | CuCl₂ | 4 | 37% | 8.3 | 205 | 773 | 88450 |
| 11 | 4A3 | Zr(BTC) | Gallic acid | FeCl₃ | 4 | 33% | 13.1 | 197 | 751 | 52557 |
| 12 | 4A4 | Zr(BTC) | Gallic acid | ZnCl₂ | 4 | 38% | 10.1 | 170 | 651 | 107175 |
| 13 | 4A5 | Zr(BTC) | Gallic acid | MgCl₂ | 4.125 | 22% | 8.06 | 202.16 | 596 | 50307.32 |
| 14 | 4A6 | Zr(BTC) | Gallic acid | FeCl₃ | 5 | 36% | 9.86 | 159.73 | 486 | 90103.25 |
| 15 | 4A7 | Zr(BTC) | Gallic acid | CuCl₂ | 4.125 | 25% | 7.32 | 220.3 | 860 | 69790.88 |
| 16 | 4A8 | Zr(BTC) | Gallic acid | NiCl₂ | 4.125 | 31% | 9.7 | 177.97 | 688 | 107403 |
| 17 | 3B | Zr(BTC) | Citric acid | — | — | — | 3.0 | 275 | 807 | 28855 |
| 18 | 4B1 | Zr(BTC) | Citric acid | ZnCl₂ | 4 | 33% | 8.2 | 149 | 550 | 80096 |
| 19 | 4B2 | Zr(BTC) | Citric acid | MgCl₂ | 4.125 | 22% | 6.33 | 158.84 | 579 | 34362.64 |
| 20 | 4B3 | Zr(BTC) | Citric acid | FeCl₃ | 5 | 27% | 7.27 | 155.41 | 588 | 72158.91 |
| 21 | 4B4 | Zr(BTC) | Citric acid | CuCl₂ | 4.125 | 11% | 5.7 | 294.1 | 1244 | 45610.74 |
| 22 | 4B5 | Zr(BTC) | Citric acid | NiCl₂ | 4.125 | 26% | 9.23 | 161.91 | 632 | 99785.83 |
| 23 | 3C | Zr(BTC) | 5-sulfo- | — | — | — | 5.2 | 349 | 1203 | 41024 |
| | | | salicylic | | | | | | | |
| | | | acid | | | | | | | |
| 24 | 4C1 | Zr(BTC) | 5-sulfo- | ZnCl₂ | 4 | 31% | 10.4 | 131 | 537 | 102965 |
| | | | salicylic | | | | | | | |
| | | | acid | | | | | | | |
| 25 | 4C2 | Zr(BTC) | 5-sulfo- | MgCl₂ | 4.125 | 22% | 7.65 | 161.87 | 635 | 54622.38 |
| | | | salicylic | | | | | | | |
| | | | acid | | | | | | | |
| 26 | 4C3 | Zr(BTC) | 5-sulfo- | CuCl₂ | 4.125 | 13% | 5.49 | 165.55 | 642 | 61910.63 |
| | | | salicylic | | | | | | | |
| | | | acid | | | | | | | |
| 27 | 4C4 | Zr(BTC) | 5-sulfo- | NiCl₂ | 4.125 | 26% | 7.43 | 148.93 | 584 | 123781.8 |
| | | | salicylic | | | | | | | |
| | | | acid | | | | | | | |
| 28 | 3D | Zr(BTC) | Tiron | — | — | — | 4.7 | 332 | 1350 | 36836 |
| 29 | 4D1 | Zr(BTC) | Tiron | ZnCl₂ | 4 | 31% | 11.2 | 168 | 606 | 115792 |
| 30 | 4D2 | Zr(BTC) | Tiron | MgCl₂ | 4.125 | 20% | 9.94 | 188.94 | 738 | 52859.52 |
| 31 | 4D3 | Zr(BTC) | Tiron | FeCl₃ | 5 | 31% | 10.24 | 163.88 | 648 | 84893.6 |
| 32 | 4D4 | Zr(BTC) | Tiron | CuCl₂ | 4.125 | 36% | 7.75 | 153.54 | 641 | 95589.17 |
| 33 | 4D5 | Zr(BTC) | Tiron | NiCl₂ | 4.125 | 29% | 12.14 | 149.09 | 658 | 139700.2 |
| 34 | 3E | Zr(BTC) | Tartaric | — | — | — | 4.2 | 443 | 2078 | 33832 |
| | | | acid | | | | | | | |
| 35 | 4E1 | Zr(BTC) | Tartaric | CuCl₂ | 4 | 32% | 7.6 | 273 | 1359 | 70514 |
| | | | acid | | | | | | | |
| 36 | 4E2 | Zr(BTC) | Tartaric | FeCl₃ | 4 | 35% | 7.7 | 234 | 967 | 98580 |
| | | | acid | | | | | | | |
| 37 | 4E3 | Zr(BTC) | Tartaric | ZnCl₂ | 4 | 35% | 10.4 | 152 | 556 | 128487 |
| | | | acid | | | | | | | |
| 38 | 4E4 | Zr(BTC) | Tartaric | MgCl₂ | 4.125 | 23% | 8.16 | 184.01 | 719 | 47215.74 |
| | | | acid | | | | | | | |
| 39 | 4E5 | Zr(BTC) | Tartaric | FeCl₃ | 5 | 30% | 10.5 | 190.72 | 527 | 81854.64 |
| | | | acid | | | | | | | |
| 40 | 4E6 | Zr(BTC) | Tartaric | CuCl₂ | 4.125 | 22% | 8.14 | 245.35 | 728 | 87972.03 |
| | | | acid | | | | | | | |
| 41 | 4E7 | Zr(BTC) | Tartaric | NiCl₂ | 4.125 | 32% | 11.77 | 178.01 | 499 | 122887.2 |
| | | | acid | | | | | | | |
| 42 | Control 8 | Zr(BDC- | — | — | — | — | 2.8 | 322 | 1011 | 14778 |
| | | NH₂) | | | | | | | | |
| 43 | Control 9 | Zr(BDC- | — | ZnCl₂ | 1.5 | 21% | 5.3 | 183 | 693 | 45453 |
| | | NH₂) | | | | | | | | |
| 44 | Control 10 | Zr(BDC- | — | MgCl₂ | 1.5 | 15% | 3.92 | 205 | 814 | 31915.68 |
| | | NH₂) | | | | | | | | |
| 45 | Control 11 | Zr(BDC- | — | FeCl₃ | 1.5 | 28% | 6.93 | 144 | 562 | 47413.07 |
| | | NH₂) | | | | | | | | |
| 46 | Control 12 | Zr(BDC- | — | CuCl₂ | 1.5 | 25% | 6.33 | 165 | 635 | 55661.68 |
| | | NH₂) | | | | | | | | |
| 47 | Control 13 | Zr(BDC- | — | NiCl₂ | 1.5 | 18% | 6.11 | 190 | 755 | 56043.2 |
| | | NH₂) | | | | | | | | |
| 48 | 6A | Zr(BDC- | Citric acid | — | | — | 4 | 200 | 700 | 34073 |
| | | NH₂) | | | | | | | | |
| 49 | 7A1 | Zr(BDC- | Citric acid | ZnCl₂ | 1.5 | 8% | 5.8 | 86 | 294 | 73628 |
| | | NH₂) | | | | | | | | |
| 50 | 7A2 | Zr(BDC- | Citric acid | MgCl₂ | 1.5 | 5% | 5.5 | 218.52 | 845 | 47413.07 |
| | | NH₂) | | | | | | | | |
| 51 | 7A3 | Zr(BDC- | Citric acid | FeCl₃ | 1.5 | 10% | 7.81 | 199.93 | 780 | 78447.32 |
| | | NH₂) | | | | | | | | |
| 52 | 7A4 | Zr(BDC- | Citric acid | CuCl₂ | 1.5 | 14% | 7.59 | 175.22 | 685 | 83328.08 |
| | | NH₂) | | | | | | | | |
| 53 | 7A5 | Zr(BDC- | Citric acid | NiCl₂ | 1.5 | 10% | 8.32 | 212.58 | 826 | 67422.86 |
| | | NH₂) | | | | | | | | |
| 54 | 6B | Zr(BDC- | Gallic acid | — | — | — | 3.06 | 267.3 | 1037 | 43190.1 |
| | | NH₂) | | | | | | | | |
| 55 | 7B1 | Zr(BDC- | Gallic acid | ZnCl₂ | 1.5 | 13% | 6.4 | 137 | 501 | 61020 |
| | | NH₂) | | | | | | | | |
| 56 | 7B2 | Zr(BDC- | Gallic acid | MgCl₂ | 1.5 | 2% | 4.94 | 201.39 | 773 | 43308.5 |
| | | NH₂) | | | | | | | | |
| 57 | 7B3 | Zr(BDC- | Gallic acid | FeCl₃ | 1.5 | 4% | 8.3 | 215.06 | 855 | 62423.7 |
| | | NH₂) | | | | | | | | |
| 58 | 7B4 | Zr(BDC- | Gallic acid | CuCl₂ | 1.5 | 14% | 8.42 | 130.26 | 513 | 72343.09 |
| | | NH₂) | | | | | | | | |
| 59 | 7B5 | Zr(BDC- | Gallic acid | NiCl₂ | 1.5 | 5% | 7.49 | 165.6 | 636 | 70027.69 |
| | | NH₂) | | | | | | | | |
| 60 | 7C1 | Zr(BDC- | Tartaric | ZnCl₂ | 1.5 | 14% | 7.4 | 97 | 349 | 67993 |
| | | NH₂) | acid | | | | | | | |
| 61 | 6D | Zr(BDC- | 3-Amino-4- | — | | — | 4.3 | 240 | 901 | 34599 |
| | | NH₂) | Hydroxy- | | | | | | | |
| | | | benzene | | | | | | | |
| | | | sulfonic | | | | | | | |
| | | | acid | | | | | | | |
| 62 | 7D1 | Zr(BDC- | 3-Amino-4- | ZnCl₂ | 1.25 | 10% | 6.5 | 186 | 669 | 69287 |
| | | NH₂) | Hydroxy- | | | | | | | |
| | | | benzene | | | | | | | |
| | | | sulfonic | | | | | | | |
| | | | acid | | | | | | | |
| 63 | 7D2 | Zr(BDC- | 3-Amino-4- | MgCl₂ | 1.5 | 9% | 4.58 | 114.77 | 417 | 34559.97 |
| | | NH₂) | Hydroxy- | | | | | | | |
| | | | benzene | | | | | | | |
| | | | sulfonic | | | | | | | |
| | | | acid | | | | | | | |
| 64 | 7D3 | Zr(BDC- | 3-Amino-4- | FeCl₃ | 1.5 | 8% | 6.46 | 128.09 | 488 | 59621.54 |
| | | NH₂) | Hydroxy- | | | | | | | |
| | | | benzene | | | | | | | |
| | | | sulfonic | | | | | | | |
| | | | acid | | | | | | | |
| 65 | 7D4 | Zr(BDC- | 3-Amino-4- | CuCl₂ | 1.5 | 13% | 4.88 | 117.69 | 445 | 68685.81 |
| | | NH₂) | Hydroxy- | | | | | | | |
| | | | benzene | | | | | | | |
| | | | sulfonic | | | | | | | |
| | | | acid | | | | | | | |
| 66 | 7D5 | Zr(BDC- | 3-Amino-4- | NiCl₂ | 1.5 | 6% | 5.13 | 144.98 | 534 | 55122.3 |
| | | NH₂) | Hydroxy- | | | | | | | |
| | | | benzene | | | | | | | |
| | | | sulfonic | | | | | | | |
| | | | acid | | | | | | | |

Comparing entries 28-33 for Zr(BTC) decorated with tiron, entries 29-33 which include impregnated metal salt have a higher ammonia uptake and longer ammonia breakthrough time than Table 3 entry 28 which is the non-salt impregnated version.

Comparing entries 34-41 for Zr(BTC) decorated with tartaric acid, each of entries 35-41 which include impregnated metal salt have higher ammonia uptake and longer ammonia breakthrough time than Table 3 entry 34 which is the non-salt impregnated version. The same trend is observed with the Zr(BDC-NH2) MOF. Comparing entries 48-53 for Zr(BDC-NH2) decorated with citric acid, entries 49-53 which include impregnated metal salt have a higher ammonia uptake and longer ammonia breakthrough time than Table 3 entry 48 which is the non-salt impregnated version. Comparing entries 54-59 for Zr(BDC-NH2) decorated with gallic acid, entries 55-59 which include impregnated metal salt have a higher ammonia uptake and longer ammonia breakthrough time than Table 3 entry 54 which is the non-salt impregnated version. Comparing entries 61-66 for Zr(BDC-NH2) decorated with 3-amino-4-hydroxybenzene sulfonic acid, entries 62-66 which include impregnated metal salt have a higher ammonia uptake and longer ammonia breakthrough time than Table 3 entry 61 which is the non-salt impregnated version. The data demonstrates that the unexpectedly high synergistic effect between the MOF, ligand, and metal salt for ammonia adsorption as measured by both ammonia uptake and breakthrough times.

Although the foregoing refers to particular embodiments, it will be understood that the invention is not so limited. It will occur to those of ordinary skill in the art that various modifications may be made to the disclosed embodiments and that such modifications are intended to be within the scope of the invention.

### Specific Embodiments

While the following is described in conjunction with specific embodiments, it will be understood that this description is intended to illustrate and not limit the scope of the preceding description and the appended claims.

A first embodiment of the invention is a metal-organic framework (MOF) composition comprising a plurality of metal nodes each having at least two coordination sites, a plurality of organic linkers, wherein the metal nodes are connected by the organic linkers bound at one or more coordination sites on the metal nodes to form a metal-organic framework; a plurality of organic ligands each comprising a coordination group bound to a coordination site of a metal node, each organic ligand having at least one functional group; and a metal salt interacting with the framework. An embodiment of the invention is one, any or all of prior embodiments in this paragraph up through the first embodiment in this paragraph wherein the coordination group of the organic ligand is selected from one or more of carboxylate, phosphonate, phosphonite, sulfonate, and sulfinate. An embodiment of the invention is one, any or all of prior embodiments in this paragraph up through the second embodiment in this paragraph wherein the at least one functional group on the organic ligand are selected from one or more of hydroxyl, amine, amino, carboxylate, sulfonate, and phosphonate. An embodiment of the invention is one, any or all of prior embodiments in this paragraph up through the second embodiment in this paragraph wherein the at least one functional group are vicinal on the organic ligand. An embodiment of the invention is one, any or all of prior embodiments in this paragraph up through the second embodiment in this paragraph wherein the organic ligand is aromatic. An embodiment of the invention is one, any or all of prior embodiments in this paragraph up through the second embodiment in this paragraph wherein the organic ligand is aliphatic. An embodiment of the invention is one, any or all of prior embodiments in this paragraph up through the second embodiment in this paragraph wherein the metal salt is interacting with the at least one functional group on the organic ligand. An embodiment of the invention is one, any or all of prior embodiments in this paragraph up through the second embodiment in this paragraph wherein the at least one functional group interacting with the metal salt are vicinal on the organic ligand. An embodiment of the invention is one, any or all of prior embodiments in this paragraph up through the second embodiment in this paragraph wherein the plurality of metal nodes comprise a metal oxo cluster comprising at least 2 metal atoms, M, selected from Zr, V, Al, Fe, Cr, Co, Ti, Hf, Cu, Zn, Ni, In, Ce, and mixtures thereof. An embodiment of the invention is one, any or all of prior embodiments in this paragraph up through the second embodiment in this paragraph wherein at least some of the metal nodes comprise zirconium. An embodiment of the invention is one, any or all of prior embodiments in this paragraph up through the second embodiment in this paragraph wherein the MOF has a static adsorption capacity for ammonia of at least 4 mmol/g measured at 10 Torr at 25° C. An embodiment of the invention is one, any or all of prior embodiments in this paragraph up through the second embodiment in this paragraph wherein the metal salt is a selected from the group of metal acetates or metal nitrates or metal halides or a combination thereof. An embodiment of the invention is one, any or all of prior embodiments in this paragraph up through the second embodiment in this paragraph wherein the metal salt is a metal halide or a combination of metal halides. An embodiment of the invention is one, any or all of prior embodiments in this paragraph up through the second embodiment in this paragraph wherein the metal salt is selected from one or more of NiCl2, ZnCl2, CuCl2, and FeCl3. An embodiment of the invention is one, any or all of prior embodiments in this paragraph up through the second embodiment in this paragraph wherein the plurality of organic linkers is selected from the group consisting of 1,3,5-benzenetricarboxylic acid, 1,4-benzenedicarboxylic acid, 1,3-benzenedicarboxylic acid, functionalized derivatives thereof, and combinations thereof.

A second embodiment of the invention is a method of manufacturing a composition comprising a MOF comprising synthesizing a metal-organic framework comprising a plurality of metal nodes each having at least two coordination sites wherein the metal nodes are connected by a plurality of organic linkers bound at one or more coordination sites on the metal nodes to form a metal-organic framework; contacting the MOF with a first solution comprising an organic ligand and a ligand incorporation solvent; contacting the ligand-modified MOF with a second solution comprising a metal salt and a salt impregnation solvent; separating the composition comprising a MOF from the solution; and activating the composition comprising a MOF.

A third embodiment of the invention is a method of capturing a target chemical in a gas stream, the method comprising providing a solid adsorbent comprising a composition comprising a MOF and contacting a gas stream comprising a target chemical with the solid adsorbent, whereby at least some of the target chemical is adsorbed by the solid adsorbent. An embodiment of the invention is one, any or all of prior embodiments in this paragraph up through the second embodiment in this paragraph wherein the target chemical is ammonia. An embodiment of the invention is one, any or all of prior embodiments in this paragraph up through the second embodiment in this paragraph wherein the ammonia in the gas stream is present in a concentration of from about 1 ppb to about 10%. An embodiment of the invention is one, any or all of prior embodiments in this paragraph up through the second embodiment in this paragraph where the MOF is formed into a shape selected from the group consisting of pellets, granules, spheres, disks, monolithic bodies, irregularly shaped particles, extrudates, and mixtures thereof. An embodiment of the invention is one, any or all of prior embodiments in this paragraph up through the second embodiment in this paragraph wherein the MOF is deposited onto a solid support selected from monoliths, spherical supports, ceramic foams, glass fibers, woven fabrics, nonwoven fabrics, membranes, pellets, extrudates, irregularly shaped particles, and mixtures thereof. An embodiment of the invention is one, any or all of prior embodiments in this paragraph up through the second embodiment in this paragraph where the solid support is a woven fabric or a nonwoven fabric. An embodiment of the invention is one, any or all of prior embodiments in this paragraph up through the second embodiment in this paragraph where the nonwoven fabric is part of a facial mask. An embodiment of the invention is one, any or all of prior embodiments in this paragraph up through the second embodiment in this paragraph the organic ligand is present as at least one molar equivalent of ligand per two metal nodes. An embodiment of the invention is one, any or all of prior embodiments in this paragraph up through the second embodiment in this paragraph the organic ligand is selected from one or more of tiron (disodium 4,5-dihydroxy-1,3-benzenedisulfonate), gallic acid, 5-sulfosalicylic acid, tartaric acid, 3,4-diaminobenzoic acid, 3,5-diaminobenzoic acid, citric acid, and 3-amino-4-hydroxybenzenesulfonic acid, 3,4-dihydroxybenzoic acid, 3,5-dihydroxybenzoic acid, 4-amino-3-hydroxybenzoic acid, 2-aminoterephthalic acid, 2,3-dihydroterephthalic acid, 2,5-dihydroterephthalic acid, pyridine-2,3-dicarboxylic acid, pyridine-2,4-dicarboxylic acid, pyridine-2,5-dicarboxylic acid, pyrazine-2,3-dicarboxylic acid, pyrazine-2,5-dicarboxylic acid, and pyrimidine-4,6-dicarboxylic acid. An embodiment of the invention is one, any or all of prior embodiments in this paragraph up through the second embodiment in this paragraph further comprising forming the ligand-modified MOF with or without a binding agent. An embodiment of the invention is one, any or all of prior embodiments in this paragraph up through the second embodiment in this paragraph wherein the ligand incorporation solvent is selected from MeOH, H₂O, DMF, acetic acid, trifluoroacetic acid, formic acid, dimethyl acetamide, sulfolane, propylene glycol, ethylene glycol, DMSO, HCl, and combinations thereof. An embodiment of the invention is one, any or all of prior embodiments in this paragraph up through the second embodiment in this paragraph wherein the salt impregnation solvent is selected from H₂O, aliphatic alcohols, acetone, DMF, and combinations thereof. An embodiment of the invention is one, any or all of prior embodiments in this paragraph up through the second embodiment in this paragraph wherein the gas stream further comprises nitrogen dioxide, sulfur dioxide, hydrogen sulfide, carbon monoxide, hydrogen cyanide, carbon dioxide, and/or chlorine. An embodiment of the invention is one, any or all of prior embodiments in this paragraph up through the second embodiment in this paragraph wherein concentrations of nitrogen dioxide, sulfur dioxide, hydrogen sulfide, carbon monoxide, hydrogen cyanide, carbon dioxide, and/or chlorine are from about 1 ppb to about 10%. An embodiment of the invention is one, any or all of prior embodiments in this paragraph up through the second embodiment in this paragraph wherein the process captures greater than 50% of the target chemical comprising the gas stream. An embodiment of the invention is one, any or all of prior embodiments in this paragraph up through the second embodiment in this paragraph wherein the process captures greater than 60% of the target chemical comprising the gas stream. An embodiment of the invention is one, any or all of prior embodiments in this paragraph up through the second embodiment in this paragraph wherein the process captures greater than 70% of the target chemical comprising the gas stream. An embodiment of the invention is one, any or all of prior embodiments in this paragraph up through the second embodiment in this paragraph wherein the target chemical is selected from the group consisting of X, Y, Z and combinations thereof.

A fourth embodiment of the invention is an article comprising a composition comprising a MOF as recited in the first embodiment of the invention.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

We claim as our invention:

1. A metal-organic framework (MOF) composition comprising:
a plurality of metal nodes each having at least two coordination sites,
a plurality of organic linkers, wherein said metal nodes are connected by said organic linkers bound at one or more coordination sites on said metal nodes to form a metal-organic framework;
a plurality of organic ligands each comprising a coordination group bound to a coordination site of a metal node, each said organic ligand having at least one functional group; and
a metal salt interacting with said framework.

2. The MOF composition of claim 1 wherein the coordination group of the organic ligand is selected from one or more of carboxylate, phosphonate, phosphonite, sulfonate, and sulfinate.

3. The MOF composition of claim 1 wherein the at least one functional group on said organic ligand is selected from one or more of hydroxyl, amine, amino, carboxylate, sulfonate, and phosphonate.

4. The MOF composition of claim 1 wherein said organic ligand has at least two functional groups, and the functional groups are vicinal on said organic ligand.

5. The MOF composition of claim 1 wherein said organic ligand is aromatic.

6. The MOF composition of claim 1 wherein said organic ligand is aliphatic.

7. The MOF composition of claim 1 wherein said metal salt is interacting with the at least one functional group on said organic ligand.

8. The MOF composition of claim 4 wherein said metal salt is interacting with the at least two functional groups on said organic ligand.

9. The MOF composition of claim 1 wherein said plurality of metal nodes comprise a metal oxo cluster comprising at least 2 metal atoms, M, selected from Zr, V, Al, Fe, Cr, Co, Ti, Hf, Cu, Zn, Ni, In, Ce, and mixtures of any two or more thereof.

10. The MOF composition of claim 9 wherein at least some of said metal nodes comprise zirconium.

11. The MOF composition of claim 1 having a static adsorption capacity for ammonia of at least 4 mmol/g measured at 10 Torr at 25° C.

12. The MOF composition of claim 1 wherein said metal salt is a selected from the group of metal acetates or metal nitrates or metal halides or a combination of any two or more thereof.

13. The MOF composition of claim 1 wherein said metal salt is a metal halide or a combination of metal halides.

14. The MOF composition of claim 1 wherein said metal salt is selected from one or more of NiCl2, ZnCl2, CuCl2, and FeCl3.

15. The MOF composition of claim 1 wherein said plurality of organic linkers is selected from the group consisting of 1,3,5-benzenetricarboxylic acid, 1,4-benzenedicarboxylic acid, 1,3-benzenedicarboxylic acid, functionalized derivatives thereof, and combinations of any two or more thereof.

16. A method of manufacturing a composition comprising a MOF of claim 1 comprising:
synthesizing a metal-organic framework comprising a plurality of metal nodes each having at least two coordination sites wherein said metal nodes are connected by a plurality of organic linkers bound at one or more coordination sites on said metal nodes to form an initial metal-organic framework;
contacting said initial MOF with a first solution comprising an organic ligand and a ligand incorporation solvent to form a ligand-modified MOF;
contacting the ligand-modified MOF with a second solution comprising a metal salt and a salt impregnation solvent;
separating the composition comprising a MOF from the solution; and
activating the composition comprising a MOF.

17. A method of capturing a target chemical in a gas stream, the method comprising:
providing a solid adsorbent comprising a MOF composition of claim 1, and
contacting a gas stream comprising a target chemical with said solid adsorbent,
whereby at least some of said target chemical is adsorbed by said solid adsorbent.

18. The process of claim 17 wherein the target chemical is ammonia.

19. The process of claim 17 wherein the ammonia in said gas stream is present in a concentration of from about 1 ppb to about 10%.

20. The process of claim 17 where the solid adsorbent is formed into a shape selected from the group consisting of pellets, granules, spheres, disks, monolithic bodies, irregularly shaped particles, extrudates, and mixtures thereof.

21. The process of claim 17 wherein the solid adsorbent is deposited onto a solid support selected from monoliths, spherical supports, ceramic foams, glass fibers, woven fabrics, nonwoven fabrics, membranes, pellets, extrudates, irregularly shaped particles, and mixtures thereof.

22. The process of claim 21 where the solid support is a woven fabric or a nonwoven fabric.

23. The process of claim 22 where the nonwoven fabric is part of a facial mask.

24. An article comprising a MOF composition as recited in claim 1.
